(19) United States
(12) Patent Application Publication
(10) Pub. No.: US 2021/0250486 A1
(43) Pub. Date: Aug. 12, 2021

(54) IMAGING APPARATUS WITH EXPOSURE TIME CONTROL, CONTROL METHOD OF IMAGING APPARATUS, AND STORAGE MEDIUM

(71) Applicant: CANON KABUSHIKI KAISHA, Tokyo (JP)

(72) Inventors: Tetsurou Kitashou, Tokyo (JP); Toshiyuki Fukui, Kanagawa (JP); Susumu Igarashi, Kanagawa (JP); Osamu Kawaguchi, Kanagawa (JP)

(21) Appl. No.: 17/167,987

(22) Filed: Feb. 4, 2021

(30) Foreign Application Priority Data
Feb. 10, 2020 (JP) 2020-020791

(51) Int. Cl. H04N 5/235; H04N 5/3745

(52) U.S. Cl. CPC H04N 5/2353; H04N 5/37455; H04N 5/2352

(57) ABSTRACT

An imaging apparatus includes an exposure time control unit, a gain control unit, and a synchronization control unit. The exposure time control unit is configured to control exposure time of each of divided areas of an imaging area of an image sensor that is configured to convert light into an electric charge and to store the electric charge. The gain control unit is configured to control an analog gain of an output of each of the areas of the image sensor when an analog-to-digital conversion is executed on the output of each of the areas of the image sensor. The synchronization control unit is configured to synchronize and control the exposure time control unit and the gain control unit.

### BACKGROUND

### Technical Field

One disclosed aspect of the embodiments relates to an imaging apparatus and a control method thereof.

### Description of the Related Art

It is known that a dynamic range of an image sensor used for a digital camera is generally smaller than a dynamic range of the natural world. Therefore, conventionally, a method for expanding the dynamic range of the image sensor has been discussed.

Respective techniques discussed in the documents of conventional art have the following issues.

With a method discussed in Japanese Patent Application Laid-Open No. 2010-136205, it is not possible to obtain a dynamic range that exceeds a range of exposure time (e.g., 1/30 sec. to 1/61440 sec.). Herein, the dynamic range obtained within a range of exposure time is the number of gradations that can be achieved by a ratio between a maximum value and a minimum value of the exposure time.

With a method discussed in Japanese Patent Application Laid-Open No. 2009-303010, the image sensor needs to have a plurality of analog-to-digital (A/D) conversion units in parallel, or an A/D conversion unit needs to be driven at high speed through a time division method.

### SUMMARY

According to an aspect of the embodiments, an imaging apparatus includes an exposure time control unit, a gain control unit, and a synchronization control unit. The exposure time control unit is configured to control exposure time of each of divided areas of an imaging area of an image sensor that is configured to convert light into an electric charge and to store the electric charge. The gain control unit is configured to control an analog gain of an output of each of the areas of the image sensor when an analog-to-digital conversion is executed on the output of each of the areas of the image sensor. The synchronization control unit is configured to synchronize and control the exposure time control unit and the gain control unit.

Further features of the disclosure will become apparent from the following description of exemplary embodiments with reference to the attached drawings.

### BRIEF DESCRIPTION OF THE DRAWINGS

FIG. 1 is a block diagram schematically illustrating a configuration of an imaging apparatus according to a first exemplary embodiment.

FIG. 2 is a diagram illustrating respective areas of an image sensor unit.

FIG. 3 is a diagram illustrating an area-by-area exposure time.

FIG. 4 is a diagram illustrating an area-by-area analog gain.

FIG. 5 is a diagram illustrating an example of an imaging condition obtained with a combination of an exposure time and an analog gain.

FIG. 6 is a diagram illustrating an imaging condition setting A for obtaining the brightest captured image.

FIG. 7 is a diagram illustrating an imaging condition setting B.

FIG. 8 is a diagram illustrating an imaging condition setting C for obtaining the darkest captured image.

FIG. 9 is a graph illustrating gradation conversion processing.

FIG. 10 is a diagram illustrating boundary gap correction processing.

FIG. 11 is a diagram illustrating synchronization control processing.

FIG. 12 is a diagram illustrating an area-by-area exposure control signal.

FIG. 13 is a block diagram schematically illustrating a configuration of an imaging apparatus according to a second exemplary embodiment.

FIG. 14 is a diagram illustrating a hierarchical structure according to a third exemplary embodiment.

### DESCRIPTION OF THE EMBODIMENTS

Thus, the disclosure is directed to a technique of expanding a dynamic range, which uses only one A/D conversion unit and needs not drive the A/C conversion unit at high speed. Hereinafter, exemplary embodiments of the disclosure will be described in detail with reference to the appended drawings. Configurations described in the following exemplary embodiment are merely examples, and the disclosure is not limited to the configurations illustrated in the appended drawings. Same reference numerals are applied to similar constituent elements or similar processing.

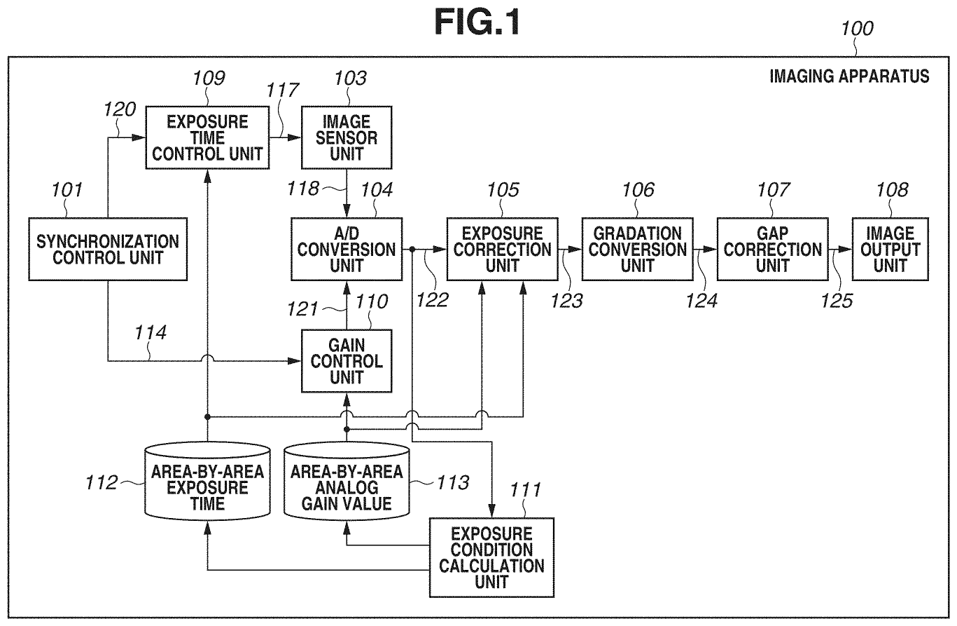

FIG. 1 is a block diagram schematically illustrating a configuration of an imaging apparatus 100 according to a first exemplary embodiment. The imaging apparatus 100 according to the present exemplary embodiment includes various constituent elements included in a general imaging apparatus. However, in order to simplify the graphical representation and description, only main constituent elements according to the present exemplary embodiment are illustrated in FIG. 1.

First, an outline of each constituent element of the imaging apparatus 100 in FIG. 1 will be described by making an image sensor unit 103 as a starting point.

In the present exemplary embodiment, an imaging area of the image sensor unit 103 is divided into a plurality of areas, and can be driven for each of the divided areas. Then, the image sensor circuit or unit 103 has a function of executing exposure operation (i.e., a function of storing electric charge) during the exposure time different for each of the areas. In the present exemplary embodiment, the exposure time is set for each area by an area-by-area exposure control signal 117 supplied from an exposure time control unit 109 described below, and the image sensor unit 103 executes exposure with the exposure time set for each of the areas. Then, the image sensor unit 103 reads electric charges stored in pixels during the exposure time set for each area by the area-by-area exposure control signal 117 as a pixel potential 118, and output the read electric charge to an analog-to-digital (A/D) conversion circuit or unit 104. Exposure of respective areas and reading of the pixel potential 118 in the image sensor unit 103 will be described below in detail.

The A/D conversion unit 104 converts the pixel potential 118 read from the image sensor unit 103 into a digital value through analog-to-digital conversion. While details will be described below, in the present exemplary embodiment, an analog gain corresponding to each of the areas (hereinafter, called “area-by-area analog gain 121) is set to the A/D conversion unit 104 by a gain control unit 110. After applying the area-by-area analog gain 121 to the pixel potential 118 received from the image sensor unit 103, the A/D conversion unit 104 converts the resultant pixel potential 118 to a digital value through analog-to-digital conversion. Hereinafter, an image composed of a digital signal obtained by subjecting the pixel potential 118 to the analog/digital conversion after applying the area-by-area analog gain 121, is called an area-by-area exposure image 122. The area-by-area exposure image 122 output from the A/D conversion unit 104 is transmitted to an exposure condition calculation unit 111 and an exposure correction unit 105.

In order to set an optimum imaging condition, the exposure condition calculation unit 111 calculates and updates an area-by-area exposure time 112 and an area-by-area analog gain value 113 based on the area-by-area exposure image 122. Then, a value of the area-by-area exposure time 112 is transmitted to the exposure time control unit 109, and the area-by-area analog gain value 113 is transmitted to the gain control unit 110. The calculation processing of the area-by-area exposure time 112 and the area-by-area analog gain value 113 executed by the exposure condition calculation unit 111 will be described below in detail.

A synchronization control circuit or unit 101 generates an exposure time output pulse 120 and a gain output pulse 114 synchronized with each other, outputs the exposure time output pulse 120 to the exposure time control unit 109, and outputs the gain output pulse 114 to the gain control unit 110. The synchronization control unit 101, the exposure time output pulse 120, and the gain output pulse 114 will be described below in detail.

Based on the values of the exposure time output pulse 120 and the area-by-area exposure time 112, the exposure time control unit 109 generates the area-by-area exposure control signal 117 for setting the exposure time for each of the areas of the image sensor unit 103, and outputs the area-by-area exposure control signal 117 to the image sensor unit 103. In this way, the exposure time of each area based on the area-by-area exposure time 112 is set to the image sensor unit 103.

Based on the gain output pulse 114 and the area-by-area analog gain value 113, the gain control unit 110 generates the area-by-area analog gain 121 for the pixel potential 118 of each of the areas of the image sensor unit 103, and outputs the area-by-area analog gain 121 to the A/D conversion unit 104. In this way, the A/D conversion unit 104 executes analog-to-digital conversion after applying the area-by-area analog gain 121 corresponding to the pixel potential 118 of each area. The analog gain generation processing executed by the gain control unit 110 will be described below in detail.

The exposure correction unit 105 generates a gradation expanded image 123 by executing gradation expansion processing on the area-by-area exposure image 122 transmitted from the A/D conversion unit 104 based on the area-by-area exposure time 112 and the area-by-area analog gain value 113. While details will be described below, the exposure correction unit 105 generates the gradation expanded image 123 expressed in 17 bits through the gradation expansion processing executed on the area-by-area exposure image 122 expressed in 10 bits. Then, the gradation expanded image 123 is transmitted to a gradation conversion unit 106.

The gradation conversion unit 106 executes gradation conversion on the gradation expanded image 123 and outputs a gradation converted image 124 to a gap correction unit 107. In the present exemplary embodiment, gradation conversion is processing of generating an 11-bit gradation converted image 124 through gamma conversion of the 17-bit gradation expanded image 123. In addition, the gradation conversion processing according to the present exemplary embodiment is executed in order to reduce a data rate in the latter part of the processing.

The gap correction unit 107 executes boundary gap correction processing on the gradation converted image 124 in order to reduce a gap (also called “boundary gap”) between the pixel values, which is likely to occur in a boundary between the areas because of the change of the exposure time and the analog gain of each area described above. In the present exemplary embodiment, the boundary gap correction processing is smoothing processing such as filter processing using a low-pass filter, which smooths a gap occurring in the boundary between the areas. A boundary gap corrected image 125 output from the gap correction unit 107 is transmitted to an image output unit 108.

The image output unit 108 outputs the boundary gap corrected image 125 to a latter-part constituent element of the imaging apparatus 100 or an external unit.

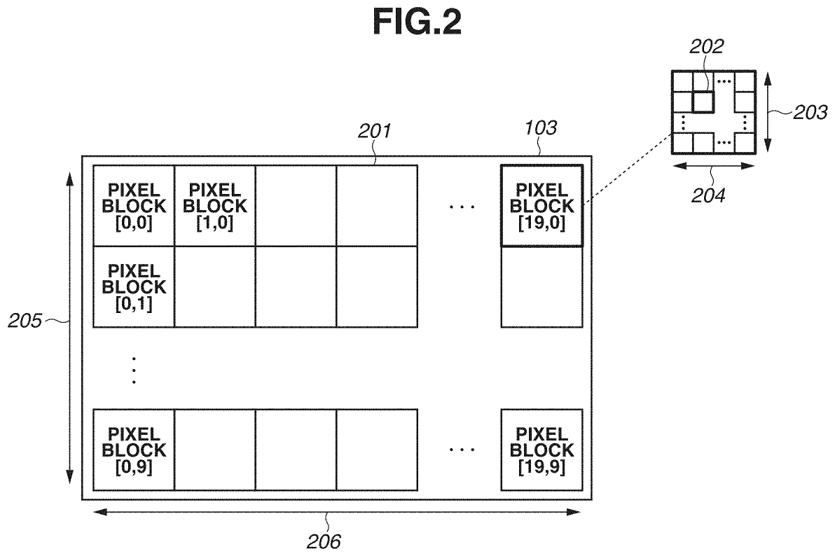

FIG. 2 is a diagram illustrating a configuration of the image sensor unit 103.

An imaging area of the image sensor unit 103 includes a plurality of pixel blocks 201, and each of the pixel blocks 201 includes a plurality of pixels 202. In the example according to the present exemplary embodiment, the number of pixels in a width 206 direction (horizontal line direction) of the imaging area of the image sensor unit 103 is 2000, and the number of pixels in a height 205 direction thereof is 1000 (i.e., the number of horizontal lines in a vertical direction is 1000). Further, the number of pixels in a width 204 direction (horizontal line direction) of the pixel block 201 is 100, and the number of pixels in a height 203 direction thereof is 100 (i.e., the number of horizontal lines in a vertical direction is 100). In this case, the number of pixel blocks 201 in the imaging area of the image sensor unit 103 is 20 in the horizontal direction and 10 in the vertical directions. Further, “pixel blocks [0,0] to [19,9]” described in the respective pixel blocks 201 in FIG. 2 represent positions of the pixel blocks 201 in the imaging area, and values within the brackets “[ ]” respectively express indexes of the pixel block 201 in the horizontal and the vertical directions in the imaging area. In FIG. 2, for example, a pixel block 201 arranged at an upper right position of the image sensor unit 103 is expressed as a pixel block [19,0]. In addition, sizes of the image sensor unit 103 and the pixel block 201 (i.e., the number of pixels in the vertical and the horizontal directions) are not limited to the above-described example. Further, a shape and an aspect ratio of the pixel 202 is not limited to the above, so that a shape thereof can be a rectangle shape instead of a square shape. Furthermore, the pixel block 201 may be configured of only one pixel 202.

Then, in the present exemplary embodiment, each of the pixel blocks 201 is configured as a unit of which the exposure time and the analog gain can be controlled.

In this case, the exposure time corresponds to a time during which electric charge is stored in the pixel (light receiving element) of the image sensor unit 103 when imaging is executed. Thus, in a case where the amount of light incident on the image sensor unit 103 is the same and the pixel is not saturated, the pixel potential 118 becomes higher as the exposure time becomes longer, i.e., a brighter image can be captured. In other words, when images are captured under the same amount of incident light with different exposure times, 1/480 sec. and 1/30 sec., for example, an image captured at the exposure time of 1/30 sec. will be brighter if saturation of the pixel is not taken into consideration.

When imaging is executed, the A/D conversion unit 104 applies the analog gain to the pixel potential 118. Thus, a digital pixel value output from the A/D conversion unit 104 (digital value obtained by analog/digital conversion executed after application of the gain) will be greater as the analog gain value is greater.

A configuration and operation of the imaging apparatus 100 according to the present exemplary embodiment will be described in detail referring back to FIG. 1.

The image sensor unit 103 executes imaging in a state where the exposure time is controlled in a unit of the pixel block 201 based on the area-by-area exposure control signal 117. Then, the image sensor unit 103 outputs the pixel potential 118 for each pixel depending on the electric charge stored therein.

The A/D conversion unit 104 applies the area-by-area analog gain 121 set for each of the pixel blocks 201 of the image sensor unit 103 to the pixel potential 118 output from the image sensor unit 103. Thereafter, the A/D conversion unit 104 executes digital conversion of the pixel potential 118 and outputs the area-by-area exposure image 122. In the present exemplary embodiment, the area-by-area exposure image 122 is a 10-bit digital value. Further, the area-by-area analog gain 121 can take four values, 1 time (×1), 2 times (×2), 4 times (×4), and 8 times (×8), as the gain values.

The exposure correction unit 105 executes gradation expansion processing on the area-by-area exposure image 122 received from the A/D conversion unit 104 based on the area-by-area exposure time 112 and the area-by-area analog gain value 113, and outputs the gradation expanded image 123. In the present exemplary embodiment, while a bit width of the area-by-area exposure image 122 is 10 bits, a bit width of the gradation expanded image 123 is 17 bits because increase in the dynamic range caused by the gradation expansion processing based on the area-by-area exposure time 112 and the area-by-area analog gain value 113 is taken into consideration.

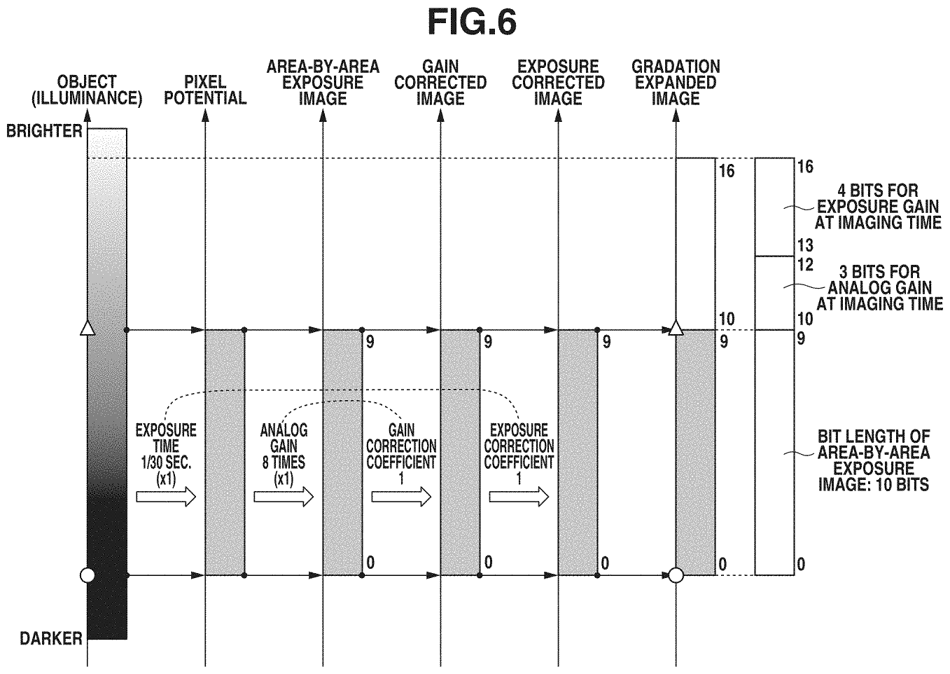

In the present exemplary embodiment, the gradation expanded image 123 having the bit width of 17 bits is merely an example. Of the 17 bits, the increased number of bits (7 bits) from the bit width (10 bits) of the area-by-area exposure image 122, includes 4 bits corresponding to the area-by-area exposure time 112 ( 1/30 sec. to 1/480 sec.), and 3 bits corresponding to the area-by-area analog gain value 113 (1 time to 8 times). The number of increased bits necessary for expressing each of the exposure time and the analog gain value is a log base 2 of a ratio of the maximum value to the minimum value of each of the exposure time and the analog gain. More specifically, the number of bits necessary for expressing the exposure time can be acquired as 4 bits (=log₂(( 1/30)/( 1/480))). For the sake of simplicity, in the present exemplary embodiment, a combination of the exposure time and the analog gain falling within comparatively small ranges is taken as an example. However, the combination is not limited thereto. For example, when the exposure time ranges from 1/30 sec. to 1/61440 sec., the increased bit width necessary for expressing the exposure time is 11 bits (=log₂(( 1/30)/( 1/61440))). In addition, the correction processing executed by the exposure correction unit 105 will be described below in detail with reference to FIG. 6.

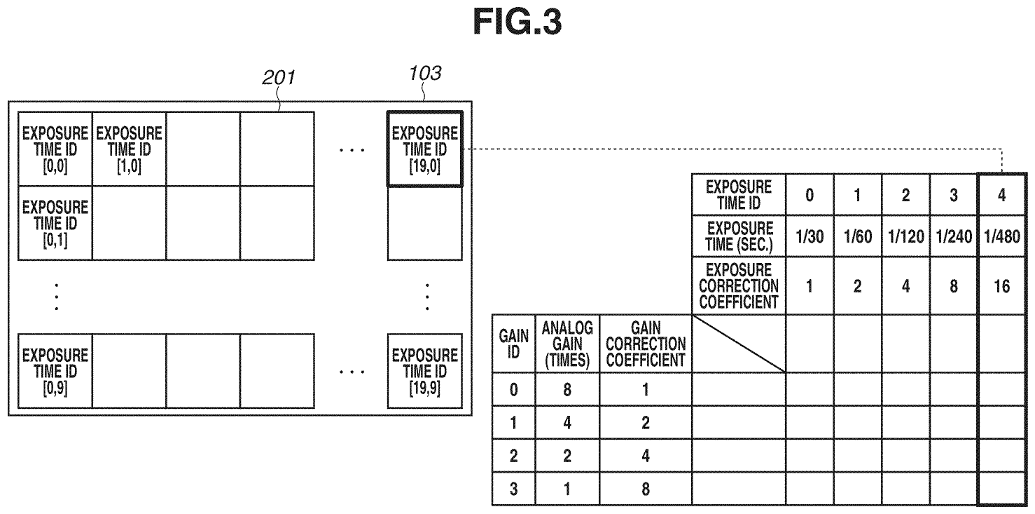

Before details of the processing executed by the exposure correction unit 105 is described, the area-by-area exposure time 112 and the area-by-area analog gain value 113 will be described with reference to FIGS. 3, 4, and 5.

First, the area-by-area exposure time 112 set for each of the pixel blocks 201 will be described with reference to FIG. 3.

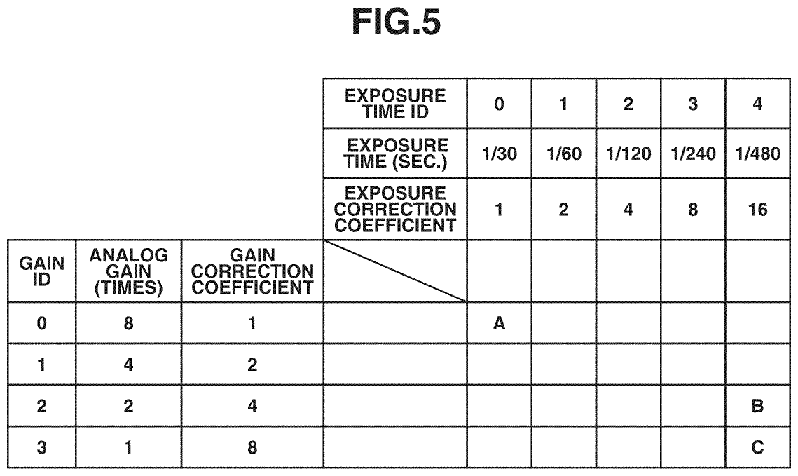

As illustrated in FIG. 3, the area-by-area exposure time 112 includes an exposure time ID, a value of the exposure time (sec.), and an exposure correction coefficient. The exposure time ID is an index that indicates the exposure time (sec.). The exposure time IDs [0,0] to [19,9] respectively described within the pixel blocks 201 in FIG. 3 represent exposure time IDs of respective pixel blocks [0,0] to [19,9] illustrated in FIG. 2. In the present exemplary embodiment, the index that indicates the exposure time ID takes a value from 0 to 4. In the example in FIG. 3, an index value of the exposure time ID [19,0] corresponding to the pixel block [19,0] at the upper right position in the imaging area is 4. In addition, actual exposure time (sec.) and an exposure correction coefficient corresponding to the exposure time ID will be described below with reference to FIG. 5.

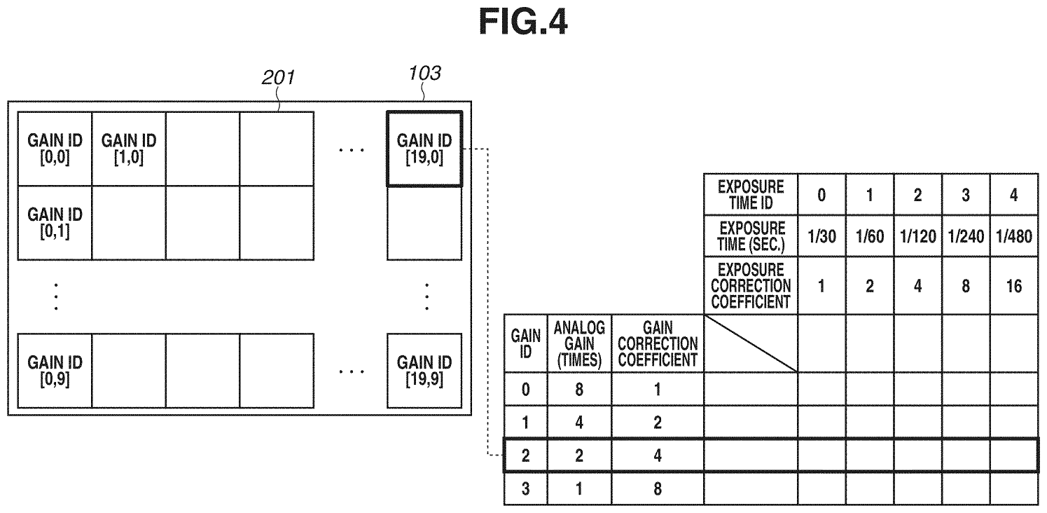

Next, the area-by-area analog gain value 113 will be described with reference to FIG. 4.

As illustrated in FIG. 4, the area-by-area analog gain value 113 includes a gain ID, a value of the analog gain, and a gain correction coefficient. The gain ID is an index that indicates an analog gain. The gain IDs [0,0] to [19,9] described within respective pixel blocks 201 in FIG. 4 represent gain IDs of respective pixel blocks [0,0] to [19,9] illustrated in FIG. 2. In the present exemplary embodiment, the index that indicates the gain ID takes a value from 0 to 3. In the example in FIG. 4, an index value of the gain ID [19,0] corresponding to the pixel block [19,0] at the upper right position in the imaging area is 2. In addition, an actual analog gain and a gain correction coefficient corresponding to the gain ID will be described below with reference to FIG. 5.

As described above, the exposure time ID takes a value 0 and 4 as an index value. An index value 0 of the exposure time ID corresponds to the exposure time 1/30 sec. Similarly, an index value 1 of the exposure time ID corresponds to the exposure time 1/60 sec., an index value 2 corresponds to the exposure time 1/120 sec., an index value 3 corresponds to the exposure time 1/240 sec., and an index value 4 corresponds to the exposure time 1/480 sec. The exposure time is one of the parameters relating to an imaging condition. In the present exemplary embodiment, 0 is specified as an index value of the exposure time ID corresponding to a condition for obtaining the brightest captured image. In a case where the brightness when imaging is executed at the exposure time for obtaining the brightest captured image (i.e., 1/30 sec.) is taken as a reference, the brightness when imaging is executed at the exposure time of 1/30 sec. to 1/480 sec. ranges from 1 to 1/16 of the reference brightness, if the same amount of light is incident on the image sensor unit 103 and no saturation occurs in the pixels. For example, when imaging is executed at the exposure time specified by the exposure time ID of the index value 4 (i.e., 1/480 sec.), the brightness is 1/16 (=( 1/480 sec.)/( 1/30 sec.)) of the brightness when imaging is executed at the exposure time specified by the exposure time ID of the index value 0 (i.e., 1/30 sec.).

Further, the exposure correction coefficient is a correction coefficient for adjusting a level of the pixel value when imaging is executed at the exposure times corresponding to the respective indexes of the exposure time IDs as described above. In the present exemplary embodiment, the exposure correction coefficient is specified so as to adjust a level of the pixel value at the exposure time ( 1/30 sec. to 1/480 sec.) by taking a level of a pixel value when imaging is executed at the exposure time for obtaining the brightest captured image (i.e., 1/30 sec.) as a reference. Thus, an inverse number of a ratio of the brightness at the time of imaging is used as the exposure correction coefficient. As described above, when the brightness when imaging is executed at the exposure time for obtaining the brightest captured image (i.e., 1/30 sec.) is taken as a reference, the brightness when imaging is executed at the exposure time of 1/30 sec. to 1/480 sec. ranges from 1 to 1/16 of the reference brightness. Accordingly, as illustrated in FIG. 5, the inverse numbers, i.e., 1 to 16 times, are used as the exposure correction coefficients.

Next, a gain ID and an analog gain and a gain correction coefficient corresponding to the gain ID will be described with reference to FIG. 5.

As described above, the gain ID takes a value from 0 to 3 as an index value. An index value 0 of the gain ID corresponds to the analog gain equivalent to 8 times. Similarly, index values 1, 2, and 3 of the gain IDs correspond to the analog gains equivalent to 4 times, 2 times, and 1 time, respectively. Similar to the above-described exposure time, the analog gain is one of the parameters relating to the imaging condition. In the present exemplary embodiment, 0 is specified as an index value of the gain ID corresponding to a condition for obtaining the brightest captured image.

The gain correction coefficient is a correction coefficient for adjusting a level of a pixel value when the analog gain corresponding to each of the indexes of the gain IDs is applied on the pixel value. In the present exemplary embodiment, a level of a pixel value when the analog gain for obtaining the brightest captured image (i.e., 8 times) is applied is taken as a reference, and levels of pixel values when respective analog gains (8 times to 1 time) are applied thereto are adjusted by the gain correction coefficients. Thus, as illustrated in FIG. 5, the gain correction coefficients of 1 time to 8 times are respectively applied to the analog gains of 8 times to 1 time.

Next, a combination of the exposure time (sec.) and the exposure correction coefficient that correspond to the exposure time ID and an analog gain and a gain correction coefficient that correspond to the gain ID will be described.

As described above, the exposure time and the analog gain are parameters relating to the imaging condition. In the present exemplary embodiment, 0 is specified as the index values of the exposure time ID and the gain ID corresponding to a condition for obtaining the brightest captured image. Accordingly, for example, a combination of the exposure time ID (exposure time 1/30 sec.) and the gain ID (analog gain 8 times) of the index values 0, indicated by a symbol “A” in FIG. 5 is a condition for obtaining the brightest captured image. Hereinafter, a setting of the imaging condition with this combination is expressed as an imaging condition setting A.

On the other hand, a combination of the exposure time ID and the gain ID of the greatest index values, indicated by a symbol “C” in FIG. 5 is a condition for obtaining the darkest captured image. Hereinafter, a setting of the imaging condition with this combination is expressed as an imaging condition setting C. The above-described combinations of the analog gain and the exposure time are merely examples, and a combination thereof is not limited to the above-described examples. In addition, an example of a combination indicated by a symbol “B” in FIG. 5 (called “imaging condition setting B”) will be described below.

Next, with reference to FIGS. 6, 7, and 8, area-by area exposure correction processing executed by the exposure correction unit 105 will be described in detail by taking the imaging condition settings A, B, and C illustrated in FIG. 5 as examples. First, the area-by-area exposure correction processing in a case of a setting for obtaining the brightest captured image (i.e., the imaging condition setting A in FIG. 5) will be described with reference to FIG. 6.

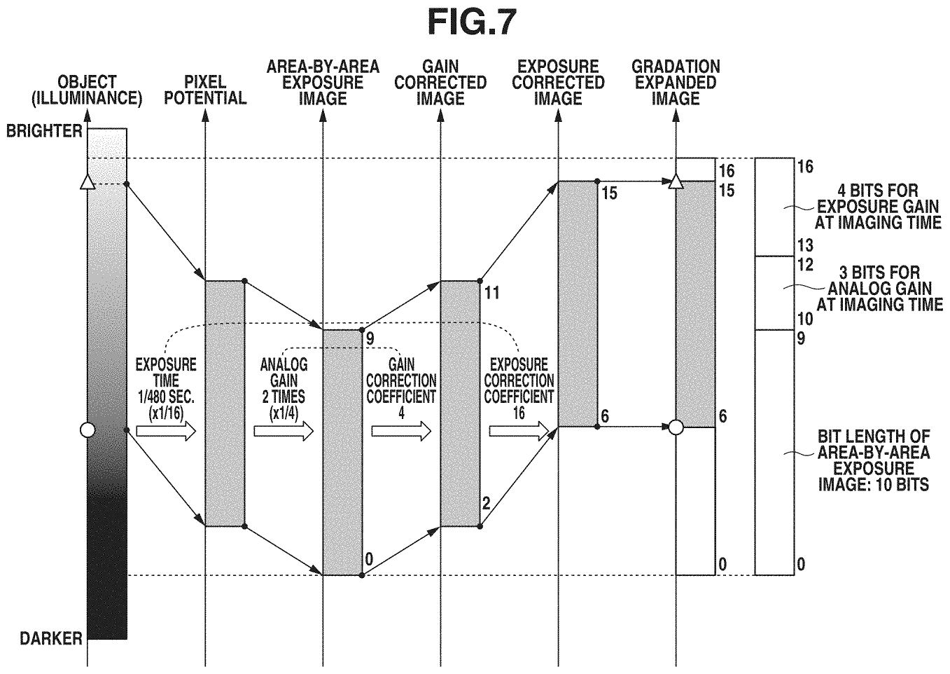

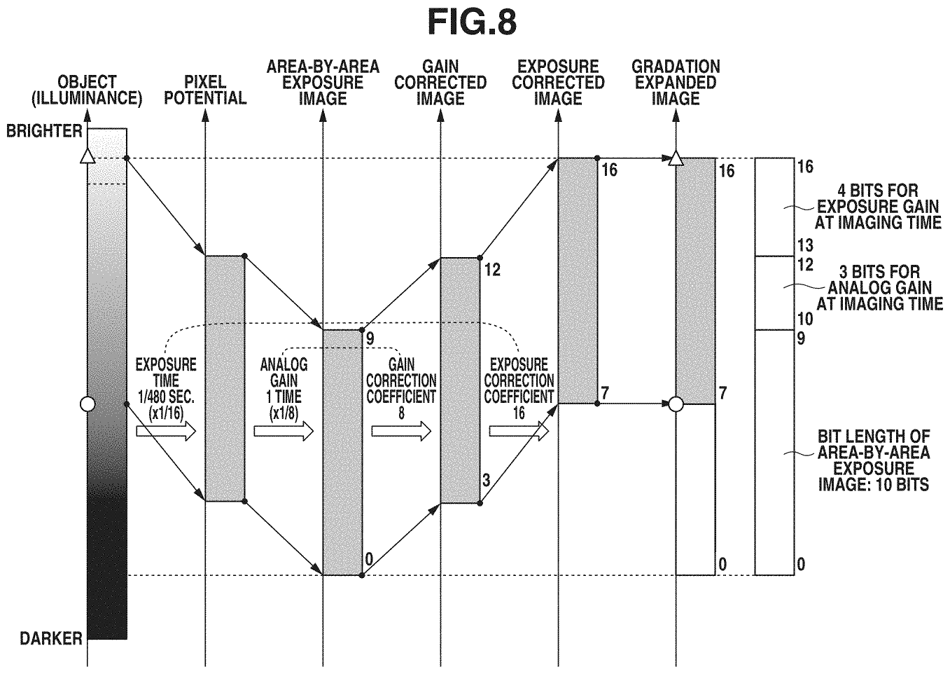

In FIG. 6, a brightness (illuminance) of an object, a pixel potential, an area-by-area exposure image, a gain corrected image, a exposure corrected image, and a gradation expanded image are respectively expressed by axes indicating brighter/darker directions. In FIG. 6, the process of processing from capturing an object image to outputting the gradation expanded image are illustrated. Further, in the example illustrated in FIG. 6, a setting for obtaining the brightest object image (i.e., the imaging condition setting A in FIG. 5) is specified as a reference setting. In this reference setting, respective axes are arranged by making a lowest luminance value (value indicated by a circle in FIG. 6) and a highest luminance value (value indicated by a triangle in FIG. 6) as references. In addition, values of the axes for expressing the object, the pixel potential, and the area-by-area exposure image are expressed by different units. However, in order to easily describe the processing executed in different settings in FIGS. 7 and 8, the respective axes in FIG. 6 are illustrated in a state where respective values corresponding to the lowest luminance and the highest luminance are arranged in a horizontal direction.

Hereinafter, transitions of respective values occurring in the process of processing from capturing an object image to outputting the gradation expanded image will be described.

As described above, the imaging condition setting A in FIG. 5 is a combination for obtaining the brightest captured image. With the imaging condition setting A, the image sensor unit 103 captures an object image at the exposure time of 1/30 sec., and the A/D conversion unit 104 executes A/D conversion by applying the analog gain of 8 times to the pixel potential output from the image sensor unit 103. In the below-described exemplary embodiment, brightness when imaging is executed with the imaging condition setting A for acquiring the brightest captured image is called “reference brightness”. Further, as described above, the area-by-area exposure image acquired through A/D conversion of the pixel potential is a 10-bit digital value.

With the above-described imaging condition setting A, the A/D conversion unit 104 executes A/D conversion using the analog gain of 8 times. Because a gain correction coefficient is 1 when the analog gain of 8 times is applied thereto, the exposure correction unit 105 applies the gain correction coefficient (1 time) to the area-by-area exposure image to output the gain corrected image. Further, in the example in FIG. 6, with the imaging condition setting A, the image sensor unit 103 executes imaging at the exposure time of 1/30 sec. Because an exposure correction coefficient is 1 when the exposure time is 1/30 sec., the exposure correction unit 105 applies the exposure correction coefficient (1 time) to the gain corrected image to output the exposure corrected image.

The area-by-area exposure image is an image obtained through imaging executed for each area of the image sensor unit 103 with the above-described combination of various imaging conditions illustrated in FIG. 5. Accordingly, the exposure correction unit 105 adjusts an image level of each area of the area-by-area exposure image. In order to adjust the level of each area, 4 bits corresponding to the above-described exposure time and 3 bits corresponding to the analog gain will be further necessary with respect to the 10 bits required for the each area of the area-by-area exposure image. More specifically, as illustrated in FIG. 5, since the exposure time ranges from 1/30 sec. to 1/480 sec., for example, if the brightness when imaging is executed at the exposure time of 1/480 sec. is to be adjusted to the reference brightness when imaging is executed at the exposure time of 1/30 sec., a level of the pixel value has to be multiplied by 16. This corresponds to +4 bits (16=2⁴). Similarly, as illustrated in FIG. 5, since the analog gain ranges from 8 times to 1 time, for example, when the brightness acquired by the analog gain of 1 time is to be adjusted to the reference brightness acquired by the analog gain of 8 times, the pixel value has to be multiplied by 8. This corresponds to +3 bits (8=2³). Thus, the exposure correction unit 105 executes bit expansion processing for adjusting the level of each area of the 10-bit exposure corrected image to output the 17-bit gradation expanded image (17 bits=10 bits+4 bits+3 bits).

As illustrated in FIG. 6, through the course of processing from capturing an object image to outputting the gradation expanded image with the setting for acquiring the brightest captured image (i.e., the imaging condition setting A), a darker side of the object is mapped on a lower bit side of the gradation expanded image. Therefore, the imaging condition setting A is appropriate for imaging of a dark area.

Next, with reference to FIG. 7, an example of the area-by-area exposure correction processing of when the exposure time and the analog gain are respectively set as 1/480 sec. and 2 times (i.e., imaging condition setting B in FIG. 5) will be described. The diagram in FIG. 7 is illustrated in a similar way as the diagram in FIG. 6.

Herein, the exposure time of 1/480 sec. is one-sixteenth times the exposure time of 1/30 sec. Therefore, if the brightness (illuminance) of the object captured at 1/480 sec. is the same as the brightness of the object captured at the reference exposure time ( 1/30 sec.), the pixel potential output when the object is captured at the exposure time of 1/480 sec. is one-sixteenth times the pixel potential output when the exposure time is the reference exposure time of 1/30 sec. Further, in the imaging condition setting B, the analog gain is set to be 2 times. This is a gain one-fourth times the reference analog gain of 8 times. Accordingly, a level of the area-by-area exposure image acquired when the analog gain is 2 times is one-fourth times the level of the area-by-area exposure image acquired when the analog gain is the reference analog gain (8 times). As a result, when the processing is executed with the imaging condition setting B in FIG. 5, a value of a brighter side of the object is mapped on the 10-bit area-by-area exposure image.

Next, the exposure correction unit 105 adjusts a value of the area-by-area exposure image to a level of the image captured at the reference imaging condition (i.e., the exposure time of 1/30 sec. and the analog gain of 8 times). When the imaging condition setting is the imaging condition setting B (the exposure time of 1/480 sec. and the analog gain of 2 times), as illustrated in FIG. 5, a gain correction coefficient is 4 (=8 times/2 times) and an exposure correction coefficient is 16 (=( 1/30 sec)/( 1/480 sec.)). Thus, the gain correction coefficient of 4 and the exposure correction coefficient of 16 are applied thereto, and the exposure corrected image is mapped on a higher bit side by 6 bits (4×16=2⁶) with respect to the area-by-area exposure image. As a result, the area-by-area exposure image is mapped on sixth bit to fifteenth bit of the 17-bit gradation expanded image.

In other words, as illustrated in the example in FIG. 7, when the processing is executed with the imaging condition setting B (the exposure time of 1/480 sec. and the analog gain of 2 times), a comparatively-brighter side of the object is mapped on the gradation expanded image.

Next, with reference to FIG. 8, the area-by-area exposure correction processing when the exposure time and the analog gain are respectively set as 1/480 sec. and 1 time (i.e., the imaging condition setting C for acquiring the darkest captured image in FIG. 5) will be described. The diagram in FIG. 8 is also illustrated in a similar way as the diagram in FIGS. 6 and 7.

As illustrated in FIG. 7, since the exposure time of 1/480 sec. is one-sixteenth times the reference exposure time of 1/30 sec., a pixel potential output when the exposure time is 1/480 sec. is one-sixteenth times the pixel potential output when the exposure time is the reference exposure time of 1/30 sec. Further, in a case of the imaging condition setting C, the analog gain is 1 time, that is a gain one-eighth times the reference analog gain of 8 times. Thus, a level of the area-by-area exposure image acquired when the analog gain is 1 time is one-eighth times the level of the area-by-area exposure image acquired when the analog gain is the reference analog gain of 8 times.

Further, in an example illustrated in FIG. 8, the exposure correction unit 105 also adjusts a value of the area-by-area exposure image to a level of the reference imaging condition (i.e., the exposure time is 1/30 sec., and the analog gain is 8 times). In the case of the imaging condition setting C (i.e., the exposure time is 1/480 sec., and the analog gain is 1 time), as illustrated in FIG. 5, the gain correction coefficient is 8 (=8 times/1 time), and the exposure correction coefficient is 16 (=( 1/30 sec.)/( 1/480 sec.)).

Thus, as illustrated in the example in FIG. 8, in a case of the imaging condition setting C (the exposure time is 1/480 sec., and the analog gain is 1 time), a brighter side of the object is mapped on the highest bit side (i.e., seventh bit to sixteenth bit) of the gradation expanded image.

As described with reference to the FIGS. 6 to 8 as examples, the exposure correction unit 105 of FIG. 1 executes the processing for converting the area-by-area exposure image 122 (10 bits) to the gradation expanded image 123 (17 bits).

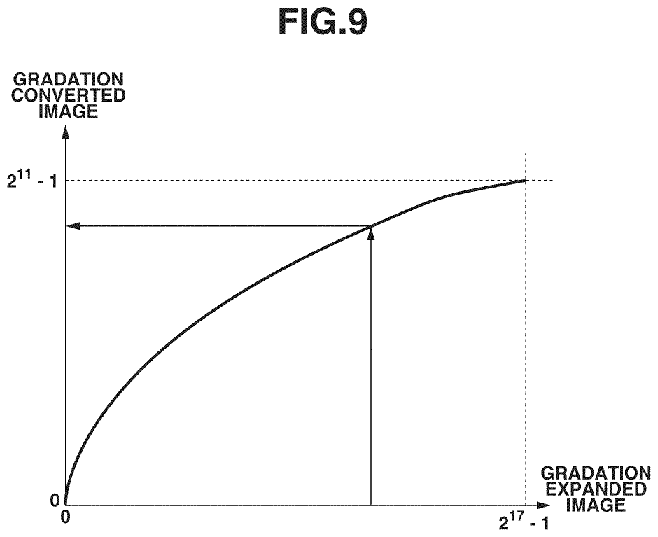

Next, gradation conversion processing executed by the gradation conversion unit 106 illustrated in FIG. 1 will be described with reference to FIG. 9.

The gradation conversion unit 106 executes gradation conversion processing on the gradation expanded image 123 (17 bits) for each pixel to convert the gradation expanded image 123 to the gradation converted image 124 (11 bits, in the present exemplary embodiment). Through the gradation conversion processing, a bit length of the gradation expanded image 123 (17 bits) is reduced, so that an output data rate from the imaging apparatus 100 can be reduced. Specifically, as illustrated in FIG. 9, the gradation conversion unit 106 maps the value of the gradation expanded image 123 (0 to 2¹⁷−1) on the gradation converted image 124 (0 to 2\hat{ }11 to 1).

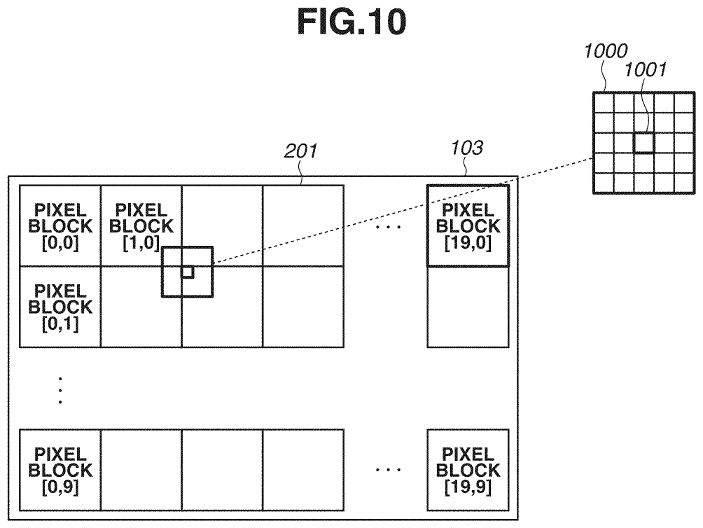

Next, boundary gap correction processing executed by the gap correction unit 107 in FIG. 1 will be described with reference to FIG. 10.

As illustrated in FIG. 10, if correction is simply executed on the exposure time and the analog gain at the time of imaging, there is a possibility that a gap between pixel values of the pixels at the boundary portion of the pixel blocks 201 remains in the image obtained by changing the imaging condition for each pixel block 201. For example, when the analog gain is 2 times, a digital value is expected to be a value 2.0 times the digital value obtained when the analog gain is 1 time. However, practically, an error (2.0+Δ times) caused by a physical property of the device is likely to occur. In such a case, there is a possibility that a gap occurs in the pixel values at the boundary portion of the adjacent pixel blocks 201.

For this reason, the gap correction unit 107 applies filter processing (smoothing processing) to a boundary portion between the pixel blocks 201 to reduce the gap between the pixel values of the boundary portion. The boundary portion is the portion at a boundary of adjacent pixel blocks 201. More specifically, as illustrated in FIG. 10, the gap correction unit 107 set pixels in the vicinity of a target pixel 1001 positioned at the boundary of the pixel blocks 201 as reference pixels 1000, and obtains an output pixel value from a value obtained by weighting and averaging the pixel values of the reference pixels 1000 and the pixel value of the target pixel 1001. Processing using a low-pass filter can be given as an example of the filter processing. Since the filter processing using the low-pass filter is known processing, description thereof will be omitted.

By executing the filter processing, the gap correction unit 107 can reduce the gap occurring in the boundary between the pixel blocks 201 of the gradation converted image 124, and output the boundary gap corrected image 125. In addition, sharpness of the image is lowered when the filter processing is executed by using a low-pass filter. However, in the present exemplary embodiment, since the filter processing is only executed on the boundary portion of the pixel blocks, lowering of sharpness of the image can be limited to only the boundary portion of the pixel blocks.

Further, in the present exemplary embodiment, although the filter processing (smoothing processing) using the low-pass filter has been described as an example, a type of the filter is not limited to the low-pass filter, and another known filter such as an epsilon filter can also be used.

In the present exemplary embodiment, respective pieces of processing have been executed by the exposure correction unit 105, the gradation conversion unit 106, and the gap correction unit 107 in FIG. 1 in this order. However, the processing order is not limited to the example illustrated in FIG. 1, and can be changed as appropriate.

Respective constituent elements from the image sensor unit 103 to the image output unit 108 have been described above. Hereinafter, the synchronization control unit 101, the exposure time control unit 109, the exposure condition calculation unit 111, and the gain control unit 110 in FIG. 1 will be described in detail.

The synchronization control unit 101 generates an exposure time output pulse 120 and a gain output pulse 114, which are synchronized with each other, transmits the exposure time output pulse 120 to the exposure time control unit 109, and transmits the gain output pulse 114 to the gain control unit 110. With this processing, the synchronization control unit 101 synchronizes and controls the processing executed by the exposure time control unit 109 and the gain control unit 110. The exposure time output pulse 120 is a signal for controlling a timing for outputting the area-by-area exposure control signal 117 from the exposure time control unit 109 to the image sensor unit 103. The exposure time control unit 109 outputs the area-by-area exposure control signal 117 to the image sensor unit 103 based on the exposure time output pulse 120 to change the exposure time for each pixel block of the image sensor unit 103. The gain output pulse 114 is a signal for controlling a timing for outputting the area-by-area analog gain 121 from the gain control unit 110 to the A/D conversion unit 104. The gain control unit 110 outputs the area-by-area analog gain 121 to the A/D conversion unit 104 based on the gain output pulse 114 to change the gain applied to the pixel potential of an optional pixel block. As described above, in the present exemplary embodiment, the synchronization control unit 101 synchronizes the exposure time control unit 109 and the gain control unit 110 to execute operation control, so that the area-by-area exposure image 122 can be acquired by appropriately changing the exposure time and the analog gain for each of the pixel blocks of the image sensor unit 103.

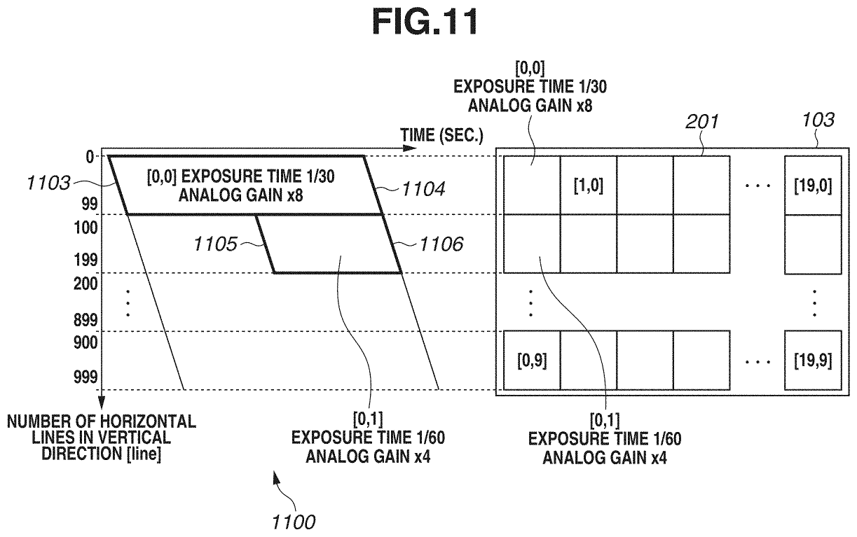

Hereinafter, with reference to FIG. 11, processing for generating the exposure time output pulse 122 and the gain output pulse 114 executed by the synchronization control unit 101, processing for controlling the exposure time executed by the exposure time control unit 109, and processing for controlling the analog gain executed by the gain control unit will be described.

In FIG. 11, processing for applying a different exposure time and a different analog gain to each of the pixel blocks will be described by taking the pixel blocks [0,0] and [0,1] as examples. As described with reference to FIG. 2, the number of pixels in a width direction (horizontal line direction) of the pixel block 201 is 100, and the number of pixels in a height direction thereof is 100 (i.e., the number of horizontal lines in a vertical direction is 100). For example, the horizontal lines in the height direction (vertical direction) of the pixel block [0,0] are the 0th to 99th lines, and the horizontal lines in the height direction (vertical direction) of the pixel block [0,1] are the 100th to 199th lines. Further, the imaging area of the image sensor unit 103 consists of the pixel blocks 201 arranged in a matrix state of 20 pieces by 10 pieces in the horizontal and the vertical directions.

In FIG. 11, a horizontal axis of a chart 1100 on the left side of the diagram represents time and a vertical axis thereof represents the number of horizontal lines in the vertical direction, and the chart 1100 illustrates operation timings for applying the exposure time and the analog gain. On the other hand, a portion on the right side of the diagram in FIG. 11 illustrates the arrangement of the pixel blocks 201 in the imaging area of the image sensor unit 103. In the following descriptions, the exposure time of 1/30 sec. and the analog gain of 8 times are applied to the pixel block 201 expressed by the upper left pixel block [0,0] in the pixel block 201. On the other hand, the exposure time of 1/60 sec. and the analog gain of 4 times are applied to the pixel block 201 expressed by the pixel block [0,1], arranged at a position one block below the pixel block [0,0] in the vertical direction.

As described above, the pixel block [0,0] is the pixel block 201 corresponding to the 0th to 99th horizontal lines. Thus, when the exposure processing and the analog gain processing are executed on the pixel block [0,0], the synchronization control unit 101 generates and outputs the exposure time output pulse 120 and the gain output pulse 114 corresponding to the 0th to 99th lines of the image sensor unit 103.

Then, based on the exposure time output pulse 120 and the area-by-area exposure time 112, the exposure time control unit 109 generates the area-by-area exposure control signal 117 for driving the image sensor unit 103 so as to execute exposure on the pixel block 201 of the 0th to 99th lines at the exposure time of 1/30 sec. Further, based on the gain output pulse 114 and the area-by-area analog gain value 113, the gain control unit 110 generates the area-by-area analog gain 121 for driving and controlling the A/D conversion unit 104 to apply the analog gain of 8 times to the pixel potential of the pixel block 201 of the 0th to 99th lines. At this time, at the pixel block [0,0], the same exposure time ( 1/30 sec.) is uniformly applied to each of the horizontal lines while shifting a timing for starting exposure indicated by a solid line 1103 and a timing for ending exposure indicated by a solid line 1104 of each of the horizontal lines. Further, the synchronization control unit 101 adjusts a timing for starting exposure so that the exposure of each of the lines of the pixel block [0,0] is ended at the same timing as the driving timing of the analog gain.

Further, as described above, the pixel block [0,1] is the pixel block 201 corresponding to the 100th to 199th horizontal lines. Thus, when the exposure processing and the analog gain processing are executed on the pixel block [0,1], the synchronization control unit 101 generates and outputs the exposure time output pulse 120 and the gain output pulse 114 corresponding to the 100th to 199th lines of the image sensor unit 103.

Then, based on the exposure time output pulse 120 and the area-by-area exposure time 112, the exposure time control unit 109 generates the area-by-area exposure control signal 117 for driving the image sensor unit 103 so as to execute exposure on the pixel block 201 of the 100th to 199th lines at the exposure time of 1/60 sec. Further, based on the gain output pulse 114 and the area-by-area analog gain value 113, the gain control unit 110 generates the area-by-area analog gain 121 for driving and controlling the A/D conversion unit 104 to apply the analog gain of 4 times to the pixel potential of the pixel block 201 of the 100th to 199th lines. Similarly, at the pixel block [0,1], the same exposure time ( 1/60 sec.) is uniformly applied to each of the horizontal lines while shifting the timings for starting and ending exposure respectively indicated by solid lines 1105 and 1106 of each of the horizontal lines. Further, the synchronization control unit 101 adjusts a timing for starting exposure so that the exposure of each of the lines of the pixel block [0,1] is ended at the same timing as the driving timing of the analog gain.

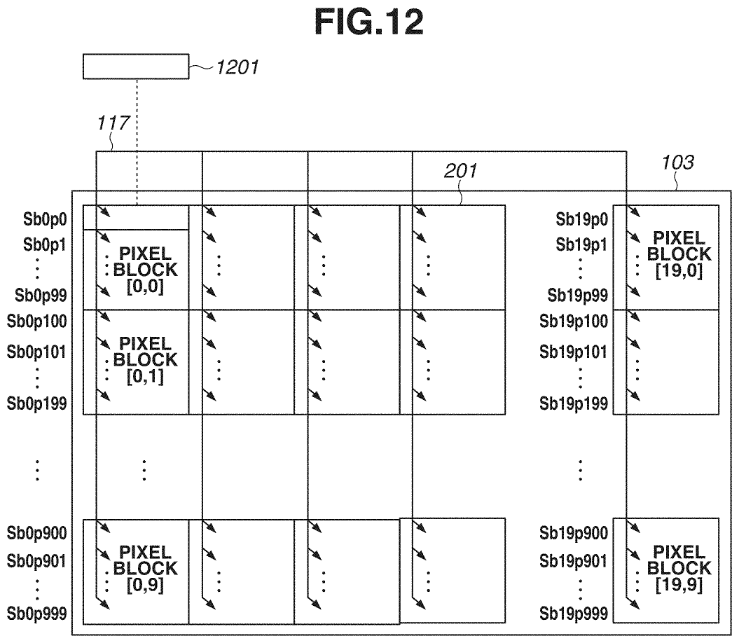

FIG. 12 is a diagram illustrating a relationship between the area-by-area exposure control signal 117 and the pixel block. The area-by-area exposure control signal 117 is a signal consisting of a bundle of pixel driving pulses for appropriately applying a different exposure time for each of the pixel blocks.

As illustrated in FIG. 12, the area-by-area exposure control signal 117 is connected to each of the lines of the pixel blocks of the image sensor unit 103, so that the exposure time of each of the pixel blocks is controlled thereby. In the example in FIG. 12, the area-by-area exposure control signal 117 is divided into pixel driving pulses sb0p0 to sb19p0, sb0p1 to sb19p1, . . . , and so on, in the horizontal direction. Further, each of the pulses is divided in a row direction and connected to each of the lines of the pixel block. Each of the pixel driving pulses can be controlled independently.

Focusing on the pixel blocks [0,0] to [0,9] positioned at the left ends in the horizontal direction, the area-by-area exposure control signal 117 is divided into the pixel driving pulses sb0p0 to sb0p999. Then, for example, the pixel driving pulse sb0p0 is connected to the first horizontal line of the pixel block [0,0]. In a general image sensor, a pixel driving pulse is connected to each of the horizontal lines in the order of the vertical direction, and a uniform exposure time is applied to the entire portion of the image sensor unit 103 by employing a rolling shutter system. On the contrary, in the present exemplary embodiment, the area-by-area exposure control signal 117 is connected to each of the pixel blocks in the horizontal direction, and different exposure time is applied to each of the pixel blocks in the horizontal direction. Further, with respect to the pixel blocks in the vertical direction, the exposure time is changed at a boundary between the pixel blocks, so that different exposure time can be applied to each of the pixel blocks.

The processing is described with reference to FIG. 1 again.

The gain control unit 110 outputs the area-by-area analog gain 121 based on the gain output pulse 114 and the area-by-area analog gain value 113. The area-by-area analog gain 121 of a desired analog gain value is applied to each of the pixel blocks specified by the area-by-area analog gain value 113.

Similarly, in FIG. 1, based on a luminance distribution of the captured area-by-area exposure image 122, the exposure condition calculation unit 111 calculates optimum setting values of the area-by-area exposure time 112 and the area-by-area analog gain value 113. More specifically, the exposure condition calculation unit 111 calculates a histogram of pixel values for each pixel block. If the pixel values are distributed on the brighter side, the exposure condition calculation unit 111 changes (updates) the area-by-area exposure time 112 and the area-by-area analog gain value 113 to the setting values for acquiring a darker image.

The processing executed by the exposure condition calculation unit 111 will be described with reference to FIGS. 7 and 8.

In the diagram in FIG. 7 illustrating the imaging example with the imaging condition setting B in FIG. 5, for example, pixel values of the brighter side should be acquired if the pixel values of the gradation expanded image 123 are distributed on the brighter side. In this case, the exposure condition calculation unit 111 updates the area-by-area exposure time 112 and the area-by-area analog gain value 113 to the setting values for acquiring a darker image. Specifically, with respect to the case of imaging with the imaging condition setting B in FIG. 7, the exposure condition calculation unit 111 changes the imaging condition setting B to the imaging condition setting C for acquiring the darkest captured image. Similarly, in a case where the pixel values are distributed on the darker side, the exposure condition calculation unit 111 executes the setting in the opposite way. As described above, the exposure condition calculation unit 111 executes the above-described processing for each of the pixel blocks.

As described above, the imaging apparatus 100 according to the present exemplary embodiment synchronizes and controls the exposure time and the analog gain for each pixel block to execute imaging. As described above, the imaging apparatus 100 of the present exemplary embodiment can expand the dynamic range corresponding to the analog gain by controlling the analog gain in addition to controlling the exposure time for each area. With respect to the case of digital gain processing, in which a digital value acquired through the A/D conversion is multiplied by a coefficient, if a value on the lower luminance side becomes 0 (i.e., underexposure) or a value on the higher luminance side becomes the maximum digital value (i.e., overexposure) after the A/D conversion is executed, gradation cannot be recovered because of the characteristic of the digital gain processing, i.e., the digital value is multiplied by the coefficient. On the contrary, adjustment of the analog gain as described in the present exemplary embodiment is advantageous in that a problem of underexposure or overexposure can be solved within a range of the analog gain. Further, according to the present exemplary embodiment, an image can be output after adjusting a level of the pixel value acquired by applying different exposure time and different analog gain for each pixel block, reducing a bit length through the gradation conversion processing, and reducing a gap occurring in the boundary between the pixel blocks.

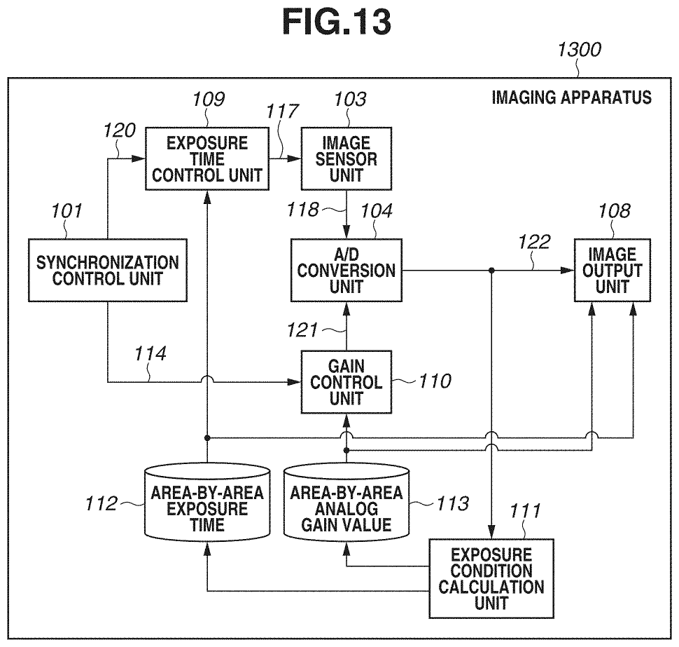

FIG. 13 is a block diagram schematically illustrating a configuration of an imaging apparatus 1300 according to a second exemplary embodiment. The imaging apparatus 1300 of the present exemplary embodiment does not have the exposure correction unit 105, the gradation conversion unit 106, and the gap correction unit 107, which are included in the imaging apparatus 100 according to the first exemplary embodiment described above.

For this reason, the imaging apparatus 1300 of the present exemplary embodiment outputs the 10-bit area-by-area exposure image 122 from the image output unit 108 as it is. The image output unit 108 also outputs the area-by-area exposure time 112 and the area-by-area analog gain value 113. In other words, according to the present exemplary embodiment, it is assumed that the processing subsequent to the processing executed by the exposure correction unit 105 in FIG. 1 is executed outside the imaging apparatus 1300. In the present exemplary embodiment, the area-by-area exposure time 112 and the area-by-area analog gain value 113 are output together with the area-by-area exposure image 122. However, the configuration is not limited thereto, and the area-by-area exposure time 112 and the area-by-area analog gain value 113 may be output through another interface (I/F) such as a serial input/output (IO) interface.

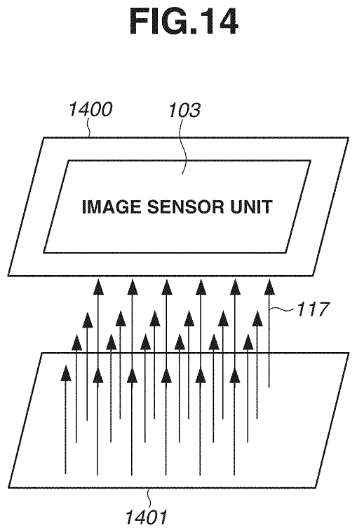

FIG. 14 is a diagram illustrating a configuration example of an imaging apparatus according to a third exemplary embodiment. The other constituent elements of the imaging apparatus of the present exemplary embodiment are similar to those of the imaging apparatus 100 of the first exemplary embodiment in FIG. 1 or the imaging apparatus 1300 of the second exemplary embodiment in FIG. 13.

As illustrated in FIG. 14, the imaging apparatus according to the present exemplary embodiment has a laminated structure consisting of two layers. A sensor layer 1400 is a layer of a side where the image sensor unit 103 is exposed to light, and a circuit layer 1401 is a layer other than the sensor layer 1400 and the image sensor unit 103. The exposure time control unit 109 is arranged on the circuit layer 1401, and respective pixel driving pulses of the area-by-area exposure control signal 117 are vertically wired between the layers of the laminated structure.

Herein, since a different exposure time is set for each area (for each pixel block) by the area-by-area exposure control signal 117, the number of wiring lines is increased. As a result, if the wiring is implemented with a normal structure consisting of a single layer, the image sensor unit 103 is interrupted by the wiring provided for the area-by-area exposure control signal 117, so that a sufficient pixel area cannot be acquired. On the contrary, the present exemplary embodiment is advantageous in that a sufficient pixel area can be acquired because only the image sensor unit 103 can be basically arranged on the sensor layer 1400. In addition, the number of layers is not limited to two, and the laminated structure may consist of three or more layers (more than two layers). Further, the configuration of the sensor layer 1400 and the circuit layer 1401 is merely an example, and constituent elements other than the image sensor unit 103 may be arranged on the sensor layer 1400.

As described above, in comparison with the method discussed in Japanese Patent Application Laid-Open No. 2010-136205, according to the first to the third exemplary embodiments, the dynamic range can be expanded within a range of the analog gain (e.g., 1 time to 8 times) in addition to a range of the exposure time. In other words, a dynamic range that exceeds a range of the exposure time (e.g., 1/30 sec. to 1/61440 sec.) cannot be acquired through the method discussed in Japanese Patent Application Laid-Open No. 2010-136205. However, through the method according to the present exemplary embodiment, a dynamic range can be expanded within a range of the analog gain. Further, compared with the method discussed in Japanese Patent Application Laid-Open No. 2009-303010, through the method according to the present exemplary embodiment, only one A/D conversion unit is used, a circuit size can be reduced, and the A/D conversion unit does not have to be driven at high speed. In other words, with the method discussed in Japanese Patent Application Laid-Open No. 2009-303010, a plurality of A/D conversion units has to be arranged in parallel, or an A/D conversion unit has to be driven at high speed through a time division method. However, according to the present exemplary embodiment, a single A/D conversion unit can be used without being driven at high speed.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions or units of one or more of the above-described embodiment(s) and/or that includes one or more circuits (e.g., application specific integrated circuit (ASIC)) for performing the functions or units of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM) device, a read only memory (ROM) device, a storage of distributed computing systems, an optical disk (such as a compact disc (CD), digital versatile disc (DVD), or Blu-ray Disc (BD)TM) a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-020791, filed Feb. 10, 2020, which is hereby incorporated by reference herein in its entirety.

What is claimed is:

1. An imaging apparatus comprising:
an exposure time control unit configured to control exposure time of each of divided areas of an imaging area of an image sensor that is configured to convert light into an electric charge and to store the electric charge;
a gain control unit configured to control an analog gain of an output of each of the areas of the image sensor when an analog-to-digital conversion is executed on the output of each of the areas of the image sensor; and
a synchronization control unit configured to synchronize and control the exposure time control unit and the gain control unit.

2. The imaging apparatus according to claim 1, further comprising an exposure correction unit configured to adjust a level of a pixel value output from the image sensor based on an exposure time and an analog gain corresponding to each of the areas of the image sensor.

3. The imaging apparatus according to claim 2, further comprising a gap correction unit configured to reduce a gap between pixel values occurring in pixels at a boundary between the areas of the image sensor after a level of the pixel value is adjusted by the exposure correction unit.

4. The imaging apparatus according to claim 3, wherein the gap correction unit includes a smoothing unit configured to smooth a gap between pixel values occurring in pixels at the boundary between the areas.

5. The imaging apparatus according to claim 4, wherein the smoothing unit executes the smoothing through a low-pass filter or an epsilon filter.

6. The imaging apparatus according to claim 2, further comprising a gradation conversion unit configured to execute gradation conversion processing for reducing gradation, with respect to the pixel value with the gradation being expanded by the exposure correction unit adjusting the level of the pixel value.

7. The imaging apparatus according to claim 1,
wherein the imaging apparatus includes a laminated structure consisting of two or more layers having the image sensor arranged on one of the layers on a side exposed to light and the exposure time control unit arranged on a layer different from the one of the layers, and
wherein a control signal from the exposure time control unit is transmitted to the image sensor through a line vertically wired between the layers of the laminated structure.

8. A control method of an imaging apparatus comprising:
performing exposure time control of each of divided areas of an imaging area of an image sensor configured to convert light into an electric charge and to store the electric charge;
performing gain control of an analog gain of an output of each of the areas when an analog-to-digital conversion is executed on the output of each of the areas of the image sensor; and
synchronizing and controlling the exposure time control and the gain control.

9. A non-transitory storage medium storing a program causing a computer to execute a control method of an imaging apparatus, the method comprising:
performing exposure time control of each of divided areas of an imaging area of an image sensor configured to convert light into an electric charge and to store the electric charge;
performing gain control of an analog gain of an output of each of the areas when an analog-to-digital conversion is executed on the output of each of the areas of the image sensor; and
synchronizing and controlling the exposure time control and the gain control.
